(19) United States
(12) Patent Application Publication
(10) Pub. No.: US 2007/0158602 A1
(43) Pub. Date: Jul. 12, 2007

(54) Valve disc for a faucet or a flusher

(75) Inventor: Su Hwang, Nan-Tou (TW)

Correspondence Address: BRUCE H. TROXELL, SUITE 1404, 5205 LEESBURG PIKE, FALLS CHURCH, VA, 22041, US

(73) Assignee: Hydrotek Corporation

(21) Appl. No.: 11/327,508

(22) Filed: Jan. 9, 2006

(51) Int. Cl. F16K 31/12

(52) U.S. Cl. 251/30.01

(57) ABSTRACT

A valve disc for a faucet or a flusher includes a main body and a valve disc. The main body is provided with a water entering passage, a water exiting passage and an electromagnetic valve. The valve disc is fixed inside the main body to separate the main body into an upper water chamber and a lower water chamber. The electromagnetic valve is able to control the pressure of the upper water chamber so as to control the water entering passage and the water exiting passage to be opened or closed. Water rushing into the lower water chamber can be released from a water passage and a water exit of a guiding rod provided on a guiding plate of the valve disc until the valve disc is closed, so the valve disc can be closed quickly.

### BACKGROUND OF THE INVENTION

1. Field of the Invention

This invention relates to a valve disc, particularly to one that has a guiding rod on a guiding plate. The guiding rod is provided with a water passage and a water exit for releasing the water in a lower water chamber so as to enable the lower water chamber to be closed promptly.

2. Description of the Prior Art

A common conventional automatic faucet or automatic urinal flusher is mainly provided with a valve disc 1, as shown in FIGS. 1 and 2, for controlling water flow between an upper water chamber 2 and a lower water chamber 3. When the water in the upper water chamber 2 flows out, the water pressure in the upper water chamber 2 and the resilient force of a spring 4 will become less than that of the lower water chamber 3. The valve disc 1 is therefore to be pushed upwards by the pressure of the lower water chamber 3. By the time, the water in the lower water chamber 3 is to flow into a passage 5. Then, when the water pressure in the upper water chamber 2 is recovered to become higher—plus the resilient force of the spring 4—than that of the lower water chamber 3, the valve disc 1 will be pushed downwards by the pressure of the upper water chamber 2 to close the lower water chamber 3, keeping the water in the lower water chamber 3 from flowing out. But, water is keeping rushing into the lower water chamber 3 to enhance its pressure during the valve disc 1 is being pushed downwards. Therefore, the valve disc 1 is to confront with a great reverse force from the lower water chamber 3 until the lower water chamber 3 is closed by the valve disc 1. In other words, it needs a greater pressure for the upper water chamber 2 to press down the valve disc 1. In addition, the water in the lower water chamber 3 cannot flow out effectively.

### SUMMARY OF THE INVENTION

The prime object of this invention is to offer a valve disc with an improved structure for a faucet or a flusher.

The main characteristics of the invention are a main body and a valve disc. The valve disc is positioned in the main body to separate the main body into an upper water chamber and a lower water chamber.

The valve disc is composed of a flexible film and a guiding plate. The guiding plate fitted in a matching chamber of the flexible film is provided with a guiding rod at its center able to pass through a central hole of the flexible film to keep the guiding plate fixed with the flexible film. The guiding rod is bored at least a water passage laterally and a water exit vertically in a lower portion communicating with the water passage. The water in the lower water chamber can still be released out through the water passage and the water exit of the guiding rod at the moment when the lower water chamber is closed, reducing effectively the internal pressure of the lower water chamber so as to enable it to be closed promptly.

### BRIEF DESCRIPTION OF DRAWINGS

This invention is better understood by referring to the accompanying drawings, wherein:

FIG. 1 is a perspective view of a conventional valve disc;

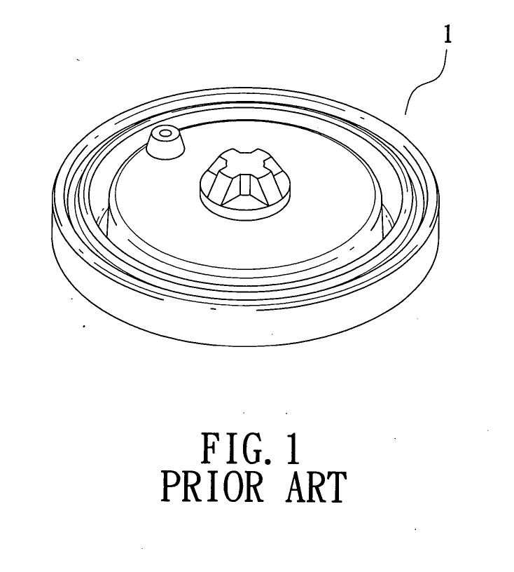

FIG. 2 is a cross-sectioned view of a conventional valve disc, showing it being used;

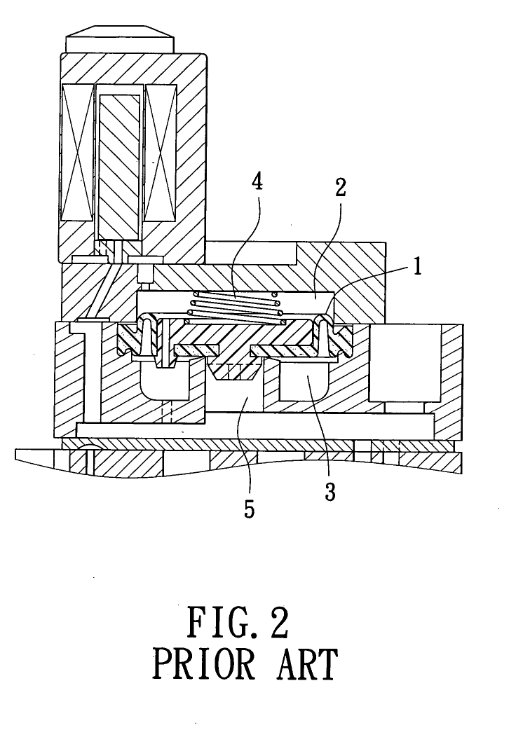

FIG. 3 is a perspective view of a preferred embodiment of a valve disc for a faucet or a flusher in the present invention;

FIG. 4 is an exploded perspective view of the preferred embodiment of a valve disc in the present invention;

FIG. 5 is a cross-sectional view of the preferred embodiment of a valve disc in the present invention, showing it being closed;

FIG. 6 is a cross-sectional view of the preferred embodiment of a valve disc in the present invention, showing it being opened; and

FIG. 7 is a partial cross-sectional view of the preferred embodiment of a valve disc in the present invention, showing it before closed.

### DETAILED DESCRIPTION OF THE PREFERRED EMBODIMENT

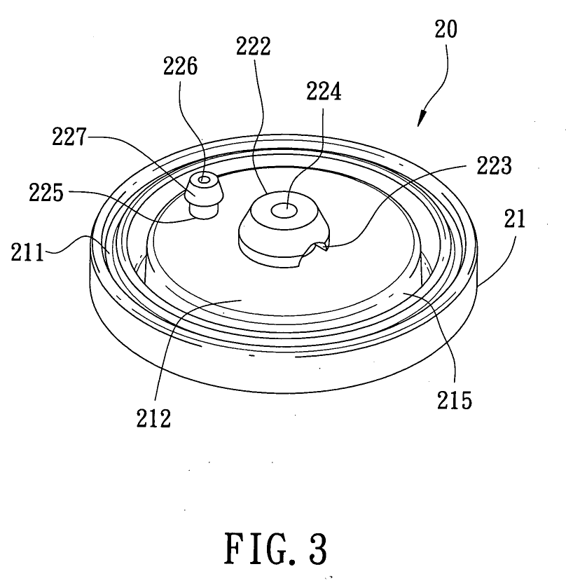

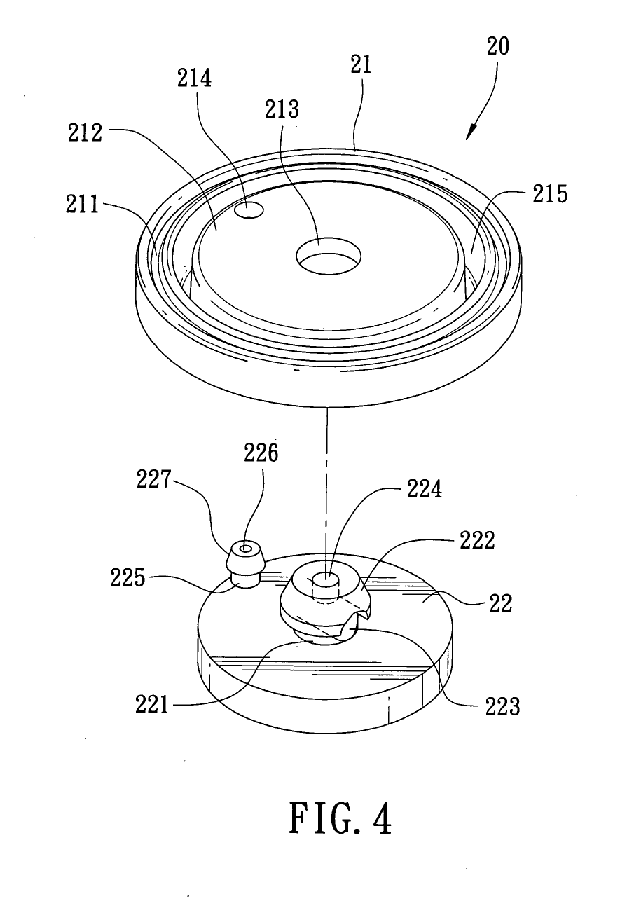

As shown in FIGS. 3, 4 and 5, a preferred embodiment of a valve disc for a faucet or a flusher in the present invention includes a main body 10 and a valve disc 20.

The main body 10 is mainly provided with a water entering passage 11, a water exiting passage 12 and an electromagnetic valve 13. The valve disc 20 is placed horizontally between the water passage 11 and the water exiting passage 12 so as to form an upper water chamber 14 and a lower water chamber 15 between the water entering passage 11 and the water exit in g passage 12. A spring 141 is inserted between the top of the upper water chamber 14 and the valve disc 20. Further, a controlling passage 131 is set below the electromagnetic valve 13.

The valve disc 20 is composed of a flexible film 21 and a guiding plate 22. The flexible film 21 formed integral is provided with a first annular groove 211 in an outer circumference for fixing the flexible film 21 with the main body 10 restrictively and a matching chamber 212 in the center. The matching chamber 212 is bored with a central hole 213 at its center and a water hole 214 at a preset position near its periphery. And, a second annular groove 215 is formed between the first annular groove 211 and the matching chamber 212. The guiding plate 22 formed as an integral round plate is provided with a guiding rod 221 on the center for fitting through the central hole 213 of the matching chamber 212. The guiding rod 221 is provided with a fixing head 222 at its top for passing through the central hole 213 to keep the guiding plate 22 in place and fixed together with the flexible film 21 restrictively and bored with a water passage 223 laterally and a water exit 224 vertically in a lower portion communicating with the water passage 223. In addition, the guiding plate 22 is provided with a water guiding rod 225 near its outer edge, which is bored with a water guiding entry 226 in its center and provided with a fixing head 227 for passing through the water hole 214 to keep the guiding plate 22 fixed together with the flexible film 21 restrictively.

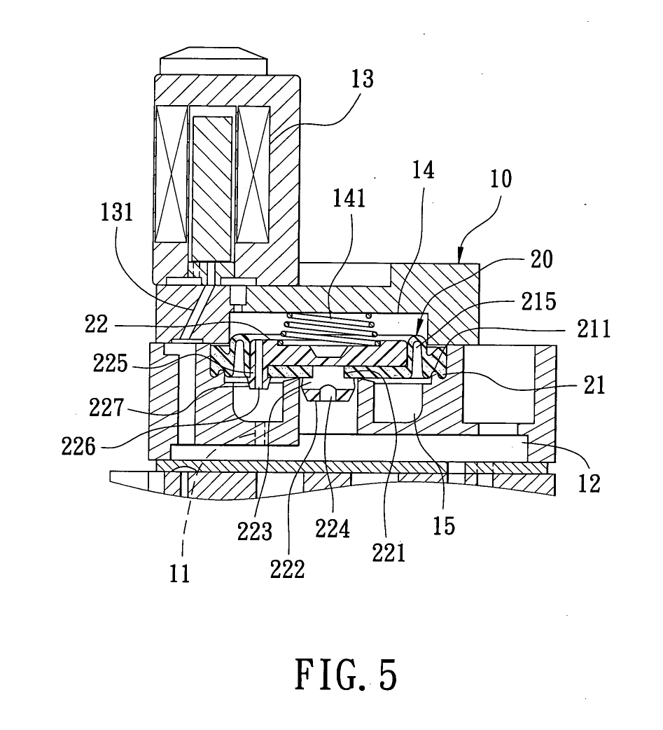

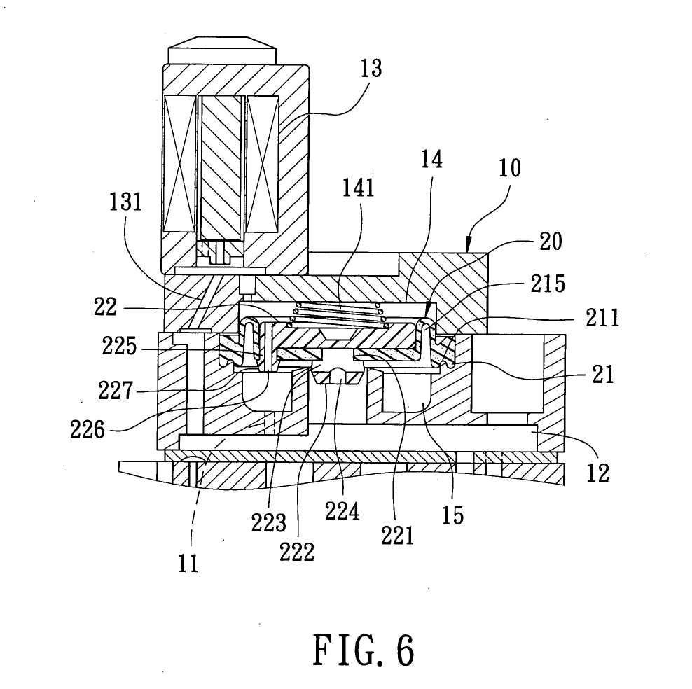

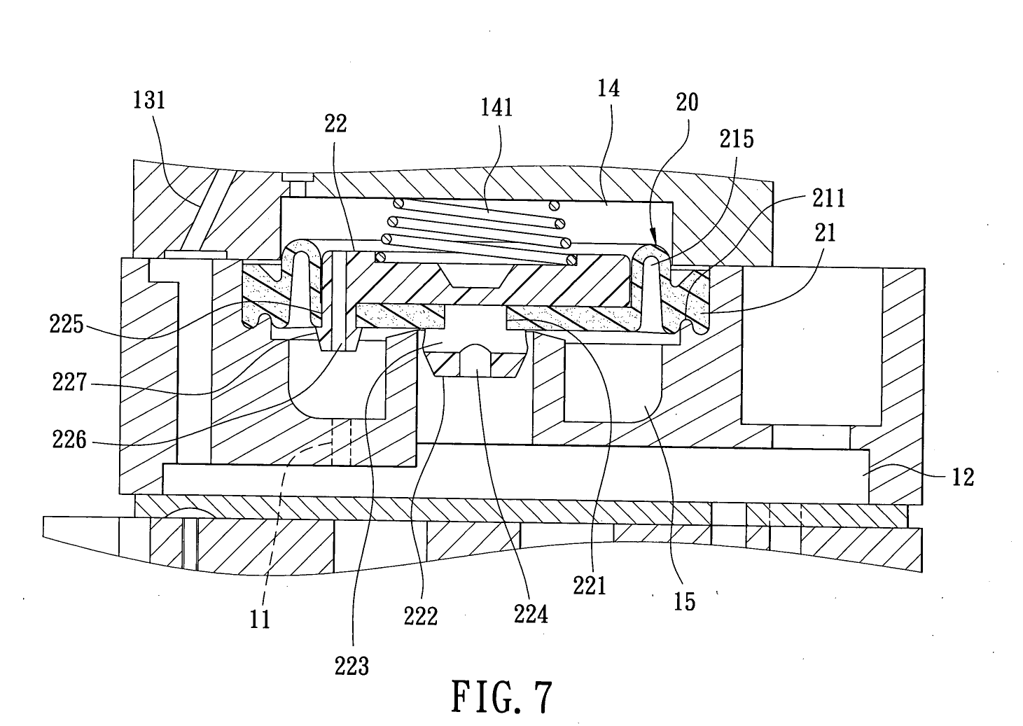

In using, as shown in FIG. 5, when the main body 10 is kept under closing condition, the water pressure of the upper water chamber 14 and the resilience of the spring 141 surpass that of the lower water chamber 15. So, the water from the water entering passage 11 cannot flow into the water exiting passage 12. When the valve disc 20 is desired to be opened, the electromagnetic valve 13 has to be electrified first, as shown in FIG. 6. Then, the water in the upper water chamber 14 is able to flow through the controlling passage 131 to the water exiting passage 12. And, the pressure in the upper water chamber 14 is gradually reduced to become less than that of the lower water chamber 15, so that the valve disc 20 will be pushed upwards and the water from the water entering passage 11 is able to flow into the water exiting passage 12. On the contrary, when the electromagnetic valve 13 is turned off, water is to flow through the water guiding entry 226 to the upper water chamber 14 continuously, so that the pressure in the upper water chamber 14 plus the resilience of the spring 141 becomes greater than that of the lower water chamber 15, enabling the valve disc 20 to be pushed downwards. Next, as shown in FIG. 7, the moment when the valve disc 20 is to be closed, water that is still rushing into the lower water chamber 15 with considerable amount can be released from the water passage 223 of the guiding rod 221 to the water exit 224 and the water exiting passage 12 orderly, enabling the valve disc 20 to be closed quickly.

The present invention has the advantages and the effects described below:

1. The very instant the valve disc 20 is pressed downwards to close the lower water chamber 15, the water in the lower water chamber 15 can flow out rapidly through the water passage 223 of the guiding rod 221 for releasing the pressure in the lower water chamber 15 so as to enable the valve disc 20 to be closed quickly.

While the preferred embodiment of the invention has been described above, it will be recognized and understood that various modifications may be made therein and the appended claims are intended to cover all such modifications that may fall within the spirit and scope of the invention.

What is claimed is:

1. A valve disc for a faucet or a flusher comprising:
a main body provided with a water entering passage, a water exiting passage and an electromagnetic valve, said water entering passage able to let water flow into said main body and said water exiting passage, said electromagnetic valve able to control the pressure of an upper water chamber so as to control said water entering passage and said water exiting passage to be opened or closed;
a valve disc consisting of a flexible film and a guiding plate and fixed between said water entering passage and said water exiting passage of said main body to separate said main body into said upper water chamber and a lower water chamber, said guiding plate provided with a guiding rod on its center, said guiding rod bored at least a water passage laterally and a water exit vertically in its lower portion in communication with said water passage.

2. A valve disc for a faucet or a flusher as claimed in claim 1, wherein said guiding rod of said guiding plate is provided with a fixing head at its top.
